(19) United States
(12) Patent Application Publication
(10) Pub. No.: US 2026/0239023 A1
(43) Pub. Date: Aug. 13, 2026

(54) TECHNIQUES FOR LOW-COMPLEXITY JOINT ANTENNA GROUP (JAG) FORMATION WITH ANALOG BEAMFORMING OF DISCRETE ANTENNAS

(71) Applicant: QUALCOMM Incorporated, San Diego, CA (US)

(72) Inventors: Vasanthan RAGHAVAN, West Windsor Township, NJ (US); Raghu Narayan Challa, San Diego, CA (US); Juergen Cezanne, Ocean Township, NJ (US)

(21) Appl. No.: 19/048,649

(22) Filed: Feb. 7, 2025

(51) Int. Cl. H04W 16/28; H01Q 3/28; H01Q 3/36; H04B 7/06; H04B 7/08; H04L 25/02; H04W 72/044; H04W 72/51

(52) U.S. Cl. CPC H04W 16/28; H01Q 3/28; H01Q 3/36; H04B 7/0617; H04B 7/0862; H04L 25/0212; H04W 72/046; H04W 72/51

(57) ABSTRACT

Example implementations include low-complexity antenna group formation in analog beamforming with discrete or uni-polarized antennas in wireless communication systems. In one implementation, the UE may receive an indication that includes antenna beamforming information associated with multiple antenna elements across multiple antenna layers. The UE may further configure one or both of a phase shifter or an amplitude control for each of the multiple antenna elements. In another implementation, a network entity may identify, based on UE hardware capability information, antenna beamforming information including the one or more virtual antenna modules, where each of the one or more virtual antenna modules forming an antenna grouping from one or both of a phase shifter or an amplitude control for each antenna element. The network entity may further transmit, to the UE, an indication that includes the antenna beamforming information associated with multiple antenna elements across multiple antenna layers.

### TECHNICAL FIELD

Aspects of the present disclosure relate generally to wireless communication systems, and more particularly, to techniques for low complexity joint antenna group (JAG) formation with analog beamforming using discrete or uni-polarized antennas.

### DESCRIPTION OF RELATED TECHNOLOGY

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as NR) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

For example, the existing New Radio (NR) framework may support multiple antenna elements for increased communication efficiency, i.e., higher throughput, lower latency, and better coverage. However, with more antenna elements come increased implementation complexity at least at the signaling or channel level in various frequency ranges. Thus, improvements in wireless communication with respect to antenna element grouping may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communications at a user equipment (UE). The method may include receiving, from a network entity, an indication that includes antenna beamforming information associated with multiple antenna elements across multiple antenna layers. The method may further include configuring one or both of a phase shifter or an amplitude control for each of the multiple antenna elements based on receiving the indication from the network entity to form one or more virtual antenna modules with each module including at least two antenna elements. The method may also include communicating, with the network entity, information using the one or more virtual antenna modules.

Another example aspect includes an apparatus for wireless communications at a UE having a plurality of antennas, comprising one or more memories and one or more processors coupled with one or more memories and configured to perform, individually or in any combination, the follow actions. The one or more processors may be configured to receive, from a network entity, an indication that includes antenna beamforming information associated with multiple antenna elements across multiple antenna layers. The one or more processors may be configured to configure one or both of a phase shifter or an amplitude control for each of the multiple antenna elements based on receiving the indication from the network entity to form one or more virtual antenna modules with each module including at least two antenna elements. The one or more processors may be configured to communicate, with the network entity, information using the one or more virtual antenna modules.

Another example aspect includes an apparatus for wireless communications at a UE, comprising means for receiving, from a network entity, an indication that includes antenna beamforming information associated with multiple antenna elements across multiple antenna layers. The apparatus may further include means for configuring one or both of a phase shifter or an amplitude control for each of the multiple antenna elements based on receiving the indication from the network entity to form one or more virtual antenna modules with each module including at least two antenna elements. The apparatus may further include means for communicating, with the network entity, information using the one or more virtual antenna modules.

Another example aspect includes a computer-readable medium comprising stored instructions for wireless communications at a UE having a plurality of antennas, the instructions are executable by one or more processors, individually or in combination, to receive, from a network entity, an indication that includes antenna beamforming information associated with multiple antenna elements across multiple antenna layers. The computer-readable medium further comprises instructions that are executable by one or more processors, individually or in combination, to configure one or both of a phase shifter or an amplitude control for each of the multiple antenna elements based on receiving the indication from the network entity to form one or more virtual antenna modules with each module including at least two antenna elements. The computer-readable medium further comprises instructions that are executable by one or more processors, individually or in combination, to communicate, with the network entity, information using the one or more virtual antenna modules.

An example aspect includes a method of wireless communications at a network entity. The method may include receiving, from a UE, an indication for network assistance in forming one or more virtual antenna modules, the indication including UE hardware capability information. The method may further include identifying, based on the received indication including the UE hardware capability information, antenna beamforming information including the one or more virtual antenna modules, where each of the one or more virtual antenna modules forming an antenna grouping at the UE from one or both of a phase shifter or an amplitude control for each antenna element from multiple antenna elements associated with multiple antenna layers. The method may further include transmitting, to the UE, an indication that includes the antenna beamforming information associated with multiple antenna elements across multiple antenna layers.

Another example aspect includes an apparatus for wireless communications at a UE having a plurality of antennas, comprising one or more memories and one or more processors coupled with one or more memories and configured to perform, individually or in any combination, the follow actions. The one or more processors may be configured to receive, from a UE, an indication for network assistance in forming one or more virtual antenna modules, the indication including UE hardware capability information. The one or more processors may be configured to identify, based on the received indication including the UE hardware capability information, antenna beamforming information including the one or more virtual antenna modules, wherein each of the one or more virtual antenna modules forming an antenna grouping at the UE from one or both of a phase shifter or an amplitude control for each antenna element from multiple antenna elements associated with multiple antenna layers. The one or more processors may be configured to transmit, to the UE, an indication that includes the antenna beamforming information associated with multiple antenna elements across multiple antenna layers

Another example aspect includes an apparatus for wireless communications at a UE, comprising means for receiving, from a UE, an indication for network assistance in forming one or more virtual antenna modules, the indication including UE hardware capability information. The apparatus may further include means for identifying, based on the received indication including the UE hardware capability information, antenna beamforming information including the one or more virtual antenna modules, wherein each of the one or more virtual antenna modules forming an antenna grouping at the UE from one or both of a phase shifter or an amplitude control for each antenna element from multiple antenna elements associated with multiple antenna layers. The apparatus may further include means for transmitting, to the UE, an indication that includes the antenna beamforming information associated with multiple antenna elements across multiple antenna layers

Another example aspect includes a computer-readable medium comprising stored instructions for wireless communications at a UE having a plurality of antennas, the instructions are executable by one or more processors, individually or in combination, to receive, from a UE, an indication for network assistance in forming one or more virtual antenna modules, the indication including UE hardware capability information. The computer-readable medium further comprises instructions that are executable by one or more processors, individually or in combination, to identify, based on the received indication including the UE hardware capability information, antenna beamforming information including the one or more virtual antenna modules, wherein each of the one or more virtual antenna modules forming an antenna grouping at the UE from one or both of a phase shifter or an amplitude control for each antenna element from multiple antenna elements associated with multiple antenna layers. The computer-readable medium further comprises instructions that are executable by one or more processors, individually or in combination, to transmit, to the UE, an indication that includes the antenna beamforming information associated with multiple antenna elements across multiple antenna layers.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various implementations of the present disclosure;

FIG. 2 is a block diagram illustrating an example of a network entity (also referred to as a base station or gNB), in accordance with various implementations of the present disclosure;

FIG. 3 is a block diagram illustrating an example of a user equipment (UE), in accordance with various implementations of the present disclosure;

FIG. 4 is a diagram illustrating an example disaggregated base station architecture, in accordance with various implementations of the present disclosure;

FIG. 5 is a conceptual diagram of a UE having a plurality of discrete antenna elements grouped into one or more virtual modules, in accordance with various implementations of the present disclosure;

FIG. 6 are chart diagrams of communicate rates for a Random 6 cluster channel and a Clustered Delay Line-D (CDL-D) channel, in accordance with various implementations of the present disclosure;

FIG. 7 is a chart diagram of downlink spectral efficiency improvement, in accordance with various implementations of the present disclosure;

FIG. 8 is a flowchart of an example of a method of wireless communications at a UE, in accordance with various implementations of the present disclosure;

FIG. 9 is a flowchart of an example of a method of wireless communications at a network entity, in accordance with various implementations of the present disclosure; and

FIG. 10 is a block diagram illustrating an example of a MIMO communication system including a base station and a UE, in accordance with various implementations of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to low complexity antenna group formation in analog beamforming with discrete or uni-polarized antennas at a user equipment (UE). Analog beamforming may correspond to the use of phase shifters and/or amplitude control to co-phase antenna elements at the radio frequency (RF) of interest. A phase shifter adjusts the phase of the signal at each antenna element. By controlling these phases, the signals from all elements can be combined constructively in the desired direction, forming a beam. It can also be used for generating a custom beam pattern targeting the instantaneous channel information including impairments such as antenna housing impact on elemental pattern, hand/body blockage, etc. In analog beamforming, amplitude control may be a technique used alongside phase shifting to further refine the directionality, side lobe control and shape of the transmitted or received beam. Amplitude control may include adjusting the amplitude (or power level) of the signal at each antenna element in the array. By varying the amplitude, the beam's shape and direction may be more precisely controlled. While phase shifting may primarily determine the direction of the beam, amplitude control may allow for shaping the beam's profile. Such techniques may be used to widen or narrow the beamwidth, reduce sidelobes, and improve the main lobe's focus.

Analog beamforming may typically be used in frequency range 2 (FR2), i.e., millimeter wave (mmWave) frequencies, for improving link budget of mmWave systems that are impaired with increased blockage, penetration, and path losses. That is, analog beamforming may help overcome the challenges of short range and line-of-sight communications in mmWave systems to direct signals and improve coverage. Analog beamforming at FR2 may be performed over dual-polarized antenna elements laid out as an antenna module. These dual-polarized elements may provide two sets of antenna elements, each over a distinct and orthogonal polarization, for the same aperture on a UE.

Given the controlled nature of the antenna module in FR2 (very similar antenna element directivity patterns, spacings between antenna elements are not obstructed with battery, sensors, etc.), the antenna elements may be highly correlated assuming that the network entity, i.e., gNodeB (gNB), applies beamforming. In some implementations, linear combining of the output signals of mutually correlated antennas with analog beamforming and feeding the result into a transmission and reception unit may be useful for many cases. Linear combination coefficients (that is, beam weights) may usually be the same for both sets, which may simplify analog beamforming. The correlation between the sets may be small providing opportunity for polarization multiple-input multiple output (MIMO) (i.e., for multiplexing or diversity gain via two layer communications). Dual-polarized antennas may provide more ports with known a priori correlations to the other ports, which may further simplify analog beamforming for FR2. The advantage of this practical approach may be that an evaluation of the sets of antenna signals that are ideal for linear combination may not be needed, and hence, analog beamforming in FR2 may be less complex and more efficient than in FR1 or FR3.

Specifically, extending analog beamforming to FR1 and FR3 frequencies may present more challenges. At these frequencies, Planar Inverted-F Antennas (PIFAs) may be used. While these antennas can be designed as dual-polarized, they may need more space and may not support wideband applications. Consequently, practical designs at FR1 and FR3 frequencies may rely on monopole or uni-polarized antennas.

At FR1 and FR3 frequencies, a large number of discrete antennas, often up to 8 or even 12, may be available at a UE. However, the number of transmission layers that can be utilized may be limited due to the small number of transceiver units (TXRUs) in UE devices, which may be configured as 2T4R (2 transmit, 4 receive) or 4T4R (4 transmit, 4 receive) or 4T6R (4 transmit, 6 receive). This configuration may result in a multitude of possible joint antenna group (JAG) combinations for each layer.

The present implementations set forth low-complexity techniques for forming joint antenna element groups (JAGs) using analog beamforming (ABF) at these frequencies. The implementations include user equipment (UE) feedback regarding hardware limitations to the gNB. The proposal shifts the responsibility of searching for optimal JAG combinations to the gNB side, where the higher computational processing demands may be more easily managed. This approach allows the gNB to process and determine the best antenna element combinations and then provide this information back to the UE, thereby optimizing performance while minimizing the computational burden on the UE.

Particular implementations of the subject matter described in this disclosure can be implemented to realize one or more of the following potential advantages. The disclosed techniques can improve coverage for UEs in various communication environments, and notably at FR1 and FR3 frequencies. By allowing the UE to hardware capability information, the network can adaptively manage joint antenna element groupings, which may also be referred to as virtual modules, thereby improving coverage in challenging environments. Further, analog beamforming may enable efficient and effective use of the spectrum, particularly in high-frequency bands where traditional omnidirectional antennas would struggle to provide adequate coverage and performance. As such, the techniques described herein may provide a flexible approach than enable a UE to improve signal quality in a coverage area, offload computational complexity and correspondingly reduce power consumption, as well as achieve higher throughputs.

Accordingly, the implementations set forth herein relate to a UE that receives, from a network entity such as a gNB, an indication that includes antenna beamforming information associated with multiple antenna elements across multiple antenna layers associated with the UE. The UE may further configure one or both of a phase shifter or an amplitude control for each of the multiple antenna elements based on receiving the indication from the gNB. The UE may also communicate information using the one or more joint antenna groups or virtual antenna modules with the gNB.

The implementations set forth herein additionally relate to a network entity that receives, from a UE, an indication including UE hardware capability information for network assistance in forming one or more joint antenna groups or virtual antenna modules associated with the UE indication. The network entity may further identify, based on the received indication including the UE hardware capability information, antenna beamforming information including the one or more virtual antenna modules. Specifically, each of the one or more virtual antenna modules may form a joint antenna grouping at the UE from one or both of a phase shifter or an amplitude control for each antenna element from multiple antenna elements associated with multiple antenna layers. The network entity may further transmit an indication that includes the antenna beamforming information associated with multiple antenna elements across multiple antenna layers to the UE.

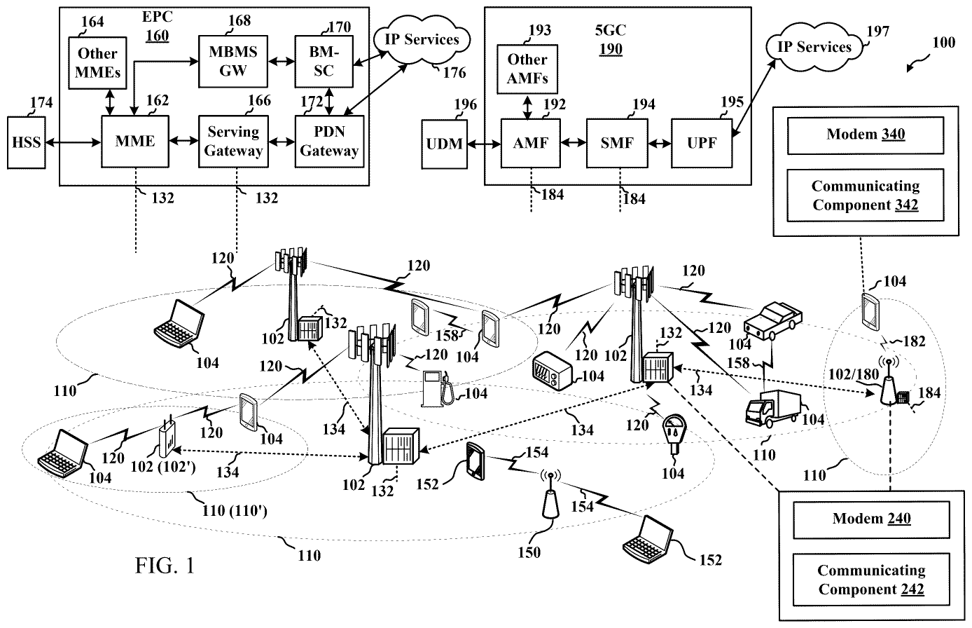

The described features will be presented in more detail below with reference to FIGS. 1-10.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) NR networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102, which may also be referred to as network entities, may include macro cells (high power cellular base station) and/or small cells (low power cellular base station). The macro cells can include base stations. The small cells can include femtocells, picocells, and microcells. In an example, the base stations 102 may also include gNBs 180, as described further herein. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

In one example, some nodes such as UE 104 of the wireless communication system may have a modem 340 and communicating component 342 for virtual module formation in analog beamforming with discrete or uni-polarized antenna elements, as described herein. Though a UE 104 is shown as having the modem 340 and communicating component 342, this is one illustrative example, and substantially any node or type of node may include a modem 340 and communicating component 342 for providing corresponding functionalities described herein.

In another example, some nodes and/or network entities such as base station 102/gNB 180, may have a modem 240 and communicating component 242 for generating and transmitting, to the UE 104, communication on a downlink channel such as a CSI request field, as described herein.

Though a base station 102/gNB 180 is shown as having the modem 240 and communicating component 242, this is one illustrative example, and substantially any node or type of node may include a modem 240 and communicating component 242 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 132, 134 and/or 184 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a AMF 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). Further, some of the UEs 104 may be referred to or otherwise correspond to AloT devices IoT UEs may include MTC/enhanced MTC (eMTC, also referred to as CAT-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. One or both of the UE 104 or the base station 102 may corresponds to a reader device capable of or otherwise configured to communicate with one or more AloT devices according to the present signaling architecture implementations described herein. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

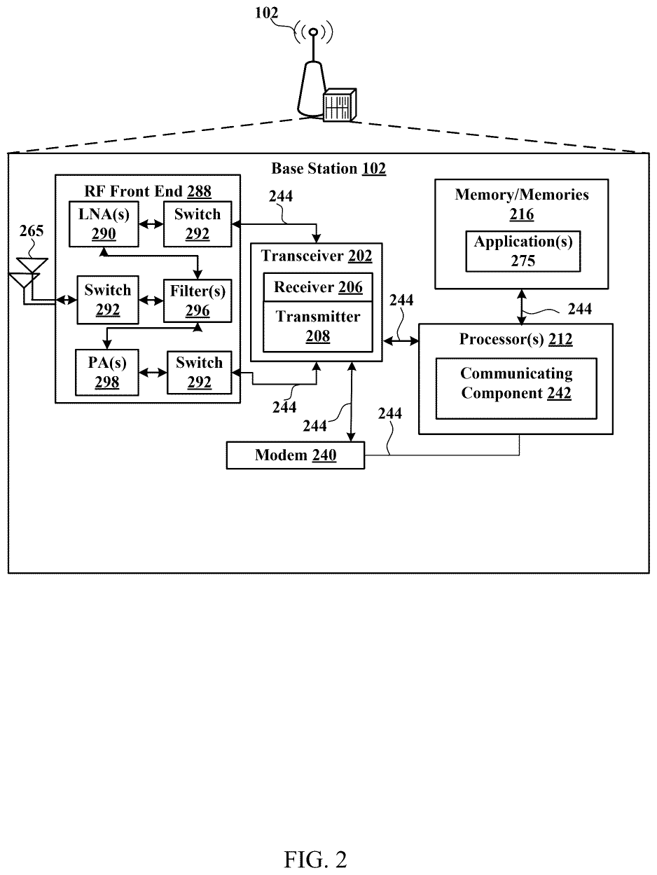

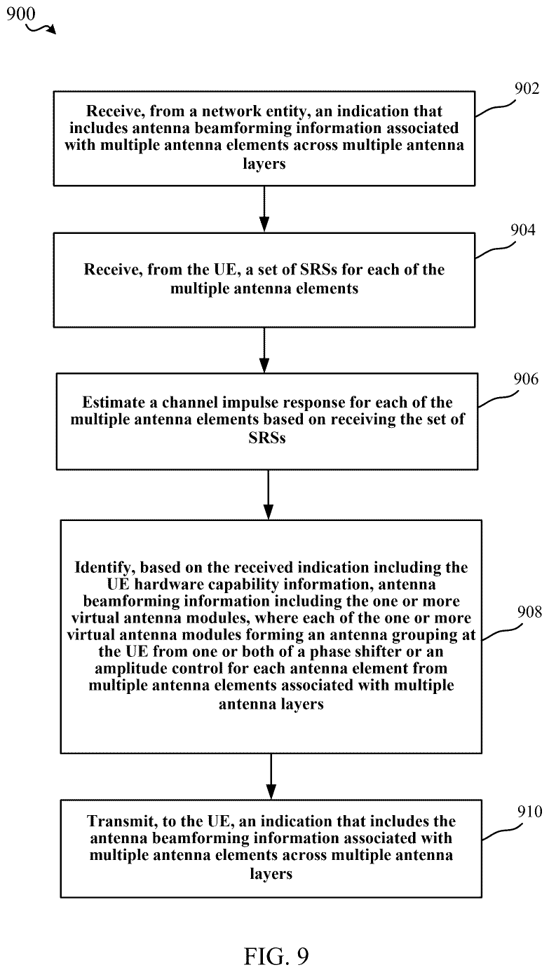

Turning now to FIGS. 2-10, aspects are depicted with reference to one or more components and one or more methods that may perform the actions or operations described herein, where aspects in dashed line may be optional. Although the operations described below in FIG. 9 is presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

Referring to FIG. 2, one example of an implementation of a node or network device, such as the base station 102 (e.g., a base station 102 and/or gNB 180, as described above, which may also be referred to or otherwise correspond to a reader device in an AIoT application) may include a variety of components, some of which have already been described above and are described further herein, including components such as one or more processors 212 and memory 216 and transceiver 202 in communication via one or more buses 244, which may operate in conjunction with modem 240 and/or communicating component 242 for virtual module formation in analog beamforming based on receiving hardware capability information from a UE having discrete or uni-polarized antenna elements.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when base station 102 is operating at least one processor 212 to execute communicating component 242 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, base station 102 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals. The antennas 265 may include one or more antennas, antenna elements, and/or antenna arrays.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

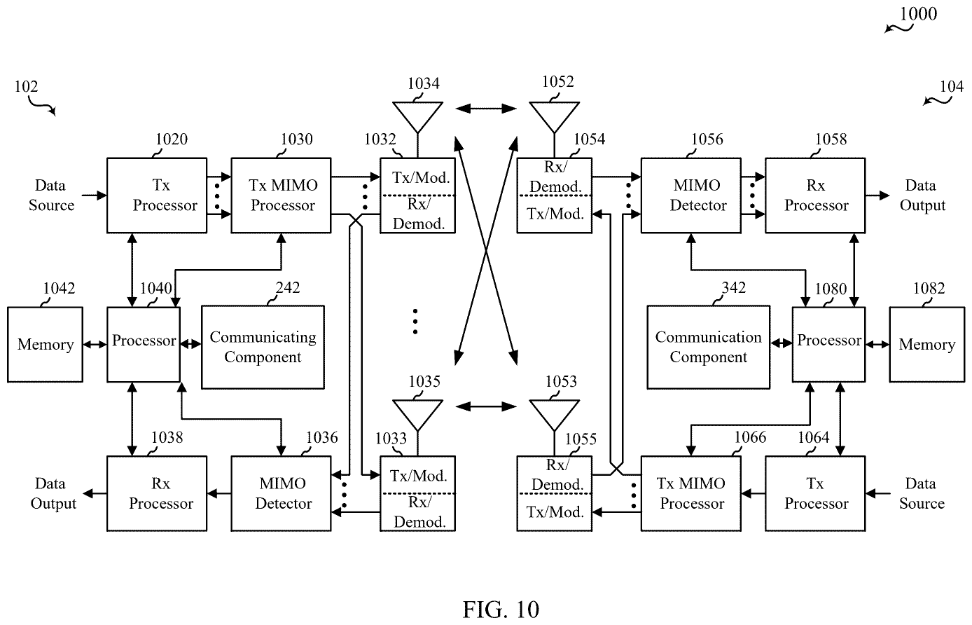

In an aspect, the processor(s) 212 may correspond to one or more of the processors described in connection with the UE in FIG. 10. Similarly, the memory 216 may correspond to the memory described in connection with the UE in FIG. 10.

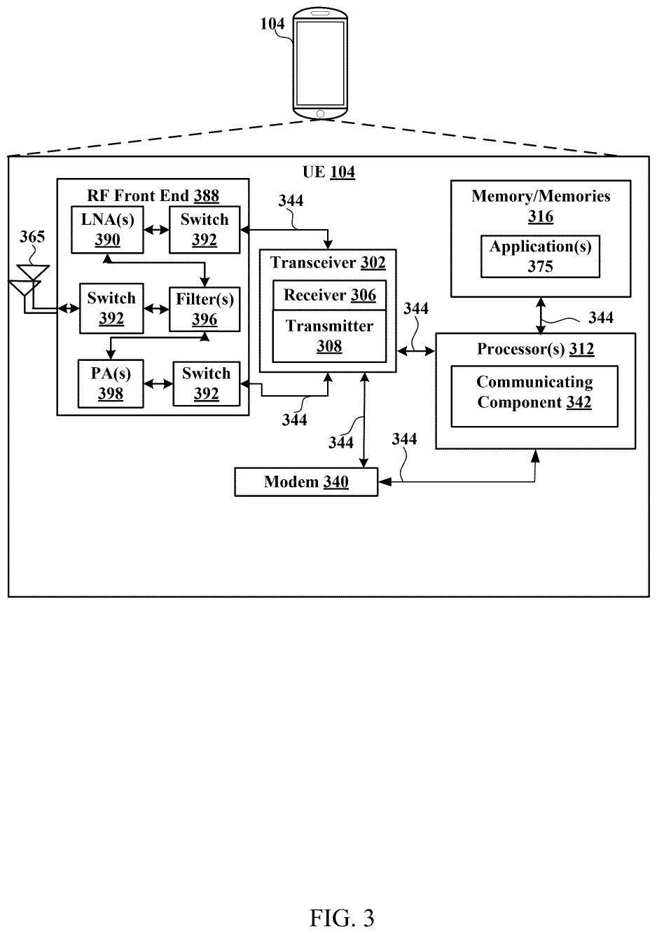

Referring to FIG. 3, one example of an implementation of UE 104. The UE 104 may include a variety of components, some of which have already been described above and are described further herein, including components such as one or more processors 312 and memory 316 and transceiver 302 in communication via one or more buses 344, which may operate in conjunction with modem 340 and/or communicating component 342 for forming virtual modules or antenna element groups as part of analog beamforming at a UE having multiple antenna elements each characterized as a discrete or uni-polarized antenna.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of base station 102, as described above, but configured or otherwise programmed for base station operations as opposed to base station operations.

In an aspect, the processor(s) 312 may correspond to one or more of the processors described in connection with the base station in FIG. 10. Similarly, the memory 316 may correspond to the memory described in connection with the base station in FIG. 10.

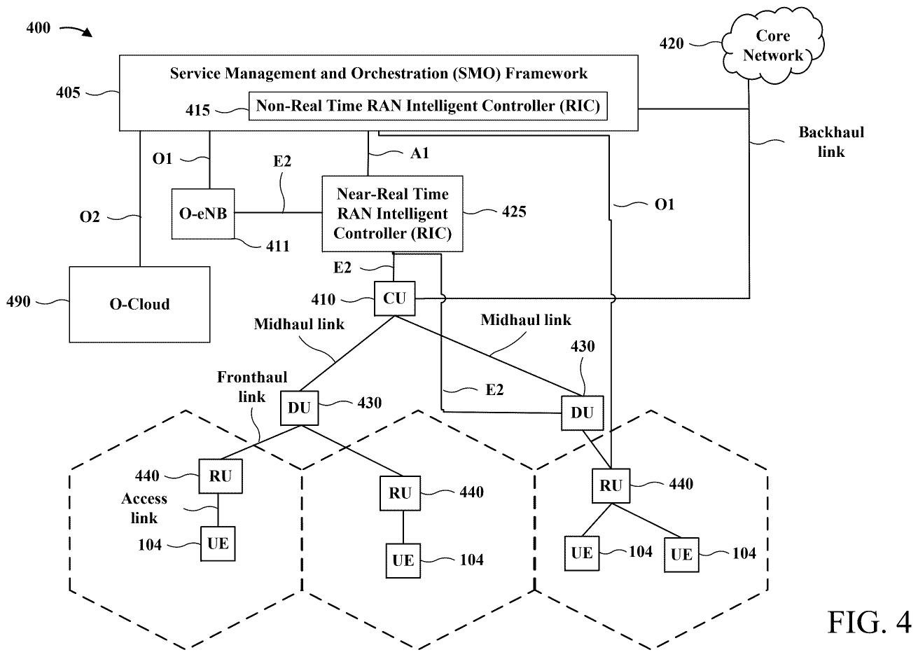

FIG. 4 is a diagram illustrating an example disaggregated base station 400 architecture. The disaggregated base station 400 may be configured to identify virtual modules or antenna element groups as part of analog beamforming for a UE having multiple antenna elements each characterized as a discrete or uni-polarized antenna. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 2105, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 2105 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

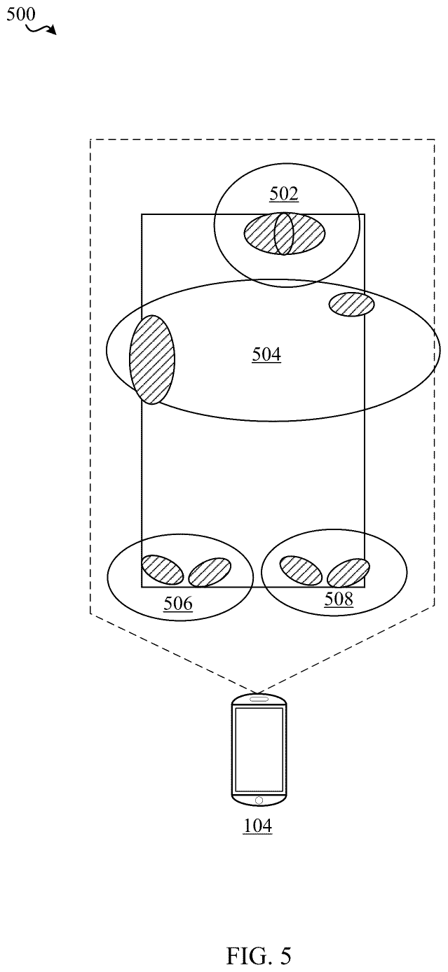

FIG. 5 is a conceptual diagram of a UE 104 having a plurality of discrete antenna elements grouped into one or more virtual modules or joint antenna groups (JAGs). Specifically, UE 104 may have eight discrete antenna elements, each operating at a certain frequency, and a number of transmit receive units. Given N discrete antenna elements at the UE 104, K_{I} (where K_{I}≥1) antennas may be combined at the radio frequency of interest to create a virtual module or joint antenna group over the I-th layer that is active (where 1≤I≤L). For example, UE 104 may have a first virtual antenna module 502, a second virtual antenna module 504, a third virtual antenna module 506, and a fourth virtual antenna module 508, each of which may include two antenna elements. The present implementations may refer to antennas and antenna elements interchangeably.

In the context of FR2 antennas, a module may be a controlled design where the antennas share a similar ground plane environment, and each antenna may be expected to radiate in the same direction. This controlled setup ensures that the antennas operate efficiently and consistently, maximizing their performance. Conversely, at FR1 and FR3, antenna placement may often not be optimized, leading to the concept of a “virtual module” or a “joint antenna group (JAG).” In this less controlled arrangement, antennas may be combined in an opportunistic manner. As a result, not all antennas radiate in the same direction, which can lead to lower overall gains compared to the more structured FR2 modules. This opportunistic approach, while flexible, may not achieve the same level of performance due to the varied radiation patterns and less uniform ground plane conditions.

In the default scenario where Kr=1, the system may select the best single antenna per layer, representing the baseline case of antenna selection diversity. This approach may simplify the configuration by focusing on optimizing a single antenna's performance for each layer. The selected or combined set of antennas per layer can be configured in various ways: can remain static, can change semi-statically, or be dynamically adjusted over time to adapt to varying conditions and requirements.

The number of layers, however, may be constrained by the number of transceiver units (TXRUs), denoted as L. Therefore, the sum of the selected antennas across all layers, represented as K₁+ . . . +K_{L}≤N, i.e., must not exceed the total number of available antennas, N. This ensures that the system operates within the hardware limitations while optimizing performance.

In the I-th layer, the antennas are combined at the RF level using a B-bit phase shifter and/or B₁-bit amplitude control. This combination allows for precise adjustments to the phase and amplitude of the signals, enhancing the beamforming capabilities and improving the overall efficiency and effectiveness of the communication system. Data transmission rate in a virtual module scenario may typically be better than the case of selecting the best single antennas over L layers.

Although virtual antenna module grouping based on UE 104 capabilities and channel conditions, i.e., sounding reference signal (SRS), may be highly beneficial, the number of antenna combinations that form the virtual antenna groupings may result in implementation complexities at the UE 104, but not at a network entity, i.e., gNB.

In an example, given N discrete antennas, in the simplest case of forming L=N/K groups/layers with K antennas per group (e.g., with each having an equal number of antennas per layer), the number of combinations may be represented as follows:

$$No . of combinations = \frac{( \begin{matrix}N \\ K\end{matrix} ) \times ( \begin{matrix}N - K \\ K\end{matrix} ) \times ( \begin{matrix}N - 2 K \\ K\end{matrix} ) \times … \times ( \begin{matrix}K \\ K\end{matrix} )}{\frac{N}{K} !}$$

With the denominator

$$\overline{\frac{N}{K} !}$$

arising due to the invariance in permutation across L groups. For instance, with N=8, K=2 antennas per group, there may be 105 virtual antenna modules possibilities to search. With N=12, K=3 antennas per group, there may be 15,400 virtual antenna modules possibilities to search. The number of computations associated with the above expression can be even larger when as the number, K, of antennas per group increases. However, not all of the above combinations are possible at the UE 104 side due to hardware constraints or restrictions (e.g., use of switches that can control a limited set of antenna elements, increased feedline/insertion losses, etc.) that allow a fixed set of antennas to be mapped to each layer.

Despite the constraints, the number of combinations may be very high from a computational perspective. Specifically, when the antenna indices mapped to each layer are denoted as:

$$\begin{matrix}\{ {i}_{1} , … , {i}_{K} \} & ∈ & {ℒ}_{1} \\ \{ {j}_{1} , … , {j}_{K} \} & ∈ & {ℒ}_{2} \\ ⋮ & & \\ \{ {m}_{1} , … , {m}_{K} \} & ∈ & {ℒ}_{N / K}\end{matrix}$$

The present implementations optimize the antenna groupings according to maximization of:

$$Rate ( {ℒ}_{1} , {ℒ}_{2} , … , {ℒ}_{N / K} )$$

More specifically, the present implementations set forth network assisted virtual antenna module formation at a UE 104. Virtual antenna module combining with network, i.e., gNB, assistance represents an approach to optimize antenna configurations for enhanced performance. This implementation leverages the capabilities of both the UE 104 and the gNB to efficiently determine the best joint antenna groupings, thereby creating virtual antenna modules that improve signal quality and network efficiency.

The UE 104, having the Channel Impulse Responses (CIRs) for all the subcarriers of interest across the N available antennas, has the capability to identify the optimal groups of antennas. These groups can be combined to form virtual antenna modules, which may be beneficial for maximizing the benefits of beamforming in wireless communication networks. However, the process of determining the best joint antenna groupings involves enormous computational processing. This not only demands substantial processing power but also leads to increased power consumption, which is a critical concern for UEs with limited battery life.

To mitigate the challenges associated with high computational demands and power consumption, an implementation is set forth herein where the gNB assists the UE 104 in determining the optimal antenna elements for each virtual antenna module. This assistance can significantly reduce the computational burden on the UE 104, allowing the UE 104 to conserve power while still achieving optimal performance. By shifting the computational processing to the gNB, which has greater processing capabilities and power resources, the system can efficiently handle the complex calculations required for optimal joint antenna grouping. The gNB can analyze the CIR data and suggest the best joint antenna groups/combinations to the UE 104.

A robust feedback mechanism may be established where the gNB communicates the recommended antenna groupings to the UE 104. This ensures that the UE 104 can quickly and efficiently configure its antennas without the need for extensive local processing. The system may dynamically adapt to changing network conditions and user requirements. The gNB may continuously monitor the network environment and update the antenna groupings as needed, ensuring that the virtual modules are always optimized for current conditions.

The use of virtual module combining with gNB assistance may enhance the effectiveness of beamforming in wireless communication networks. By ensuring that the best possible joint antenna groups/configurations are used, the system can achieve higher data rates, improved signal quality, and more reliable connections. The techniques described herein also facilitate the deployment of advanced beamforming techniques, such as massive MIMO, by providing a flexible and efficient framework for antenna management.

In one implementation, the UE 104 may indicate a request for gNB assistance in forming antenna groups across one or more antenna layers. The UE 104 may also indicate any hardware constraints to the gNB, i.e., which antenna combinations are possible or are not possible and phase shifter and/or amplitude control constraints. The UE 104 indication may signify a number of UE antennas (N), how many antenna layers the UE 104 can use (L, also indicated as a device capability), and a minimum or maximum number of antennas that can be mapped per layer (K). Additionally, the UE indication may signify which antenna elements can be mapped to which layer or to different layers. In one example, if N=8, antennas 1-4 can be mapped to layers 1-2, whereas antennas 5-8 can be mapped to layers 3-4. In another example, antennas 1-2 can be mapped to layer 1, antennas 3-4 to layer 2, and antennas 5-8 to layers 3 and 4 with different possible sets of antennas mapped to layers 3 and 4. The UE indication can may also include information on which antennas are restricted on which layers (a complementary approach which may incur less feedback overhead in certain scenarios).

In another implementation, the UE 104 may perform uplink sounding with each antenna so that the gNB may determine the uplink CIR from each antenna. Uplink sounding refers to the process where the UE 104 transmits specific reference signals to the network, i.e., sounding reference signals (SRS). SRS may provide the network with information about the uplink channel conditions and may be used by the gNodeB to estimate the uplink channel characteristics. Due to downlink-uplink circuit differences, uplink sounding can adjust for any mismatches as well.

In some wireless communication systems, the process of determining the optimal joint antenna grouping may be implemented to significantly enhance network performance. This process may be based on the CIR estimated at the gNB, which provides information about the channel conditions, as well as the indicated hardware constraints of the UE 104. The gNB may further leverage its computational capabilities, and determine the best joint antenna grouping while considering the indicated hardware constraints.

The gNB can determine the best joint antenna grouping based on the extent to which the data rate can be optimized, correlation can be maximized, and orthogonality between antenna groups can be ensured. Specifically, by selecting the optimal combination of antennas, the gNB can enhance the data transmission rate. This involves choosing antennas that provide the best signal quality and coverage, thereby maximizing throughput. Maximizing the correlation between antenna elements may be determined to improve the coherence of the transmitted signals, leading to better signal quality and reliability. The measure of orthogonality between each antenna group may be increased to reduce the interference and improving the overall efficiency of the network, especially in environments with high user density.

Unlike the UE 104, the gNB may tolerate higher computational overheads because it is a network entity with more robust processing capabilities. This may allow the gNB to perform complex calculations and optimizations that would be challenging for the UE 104, which may be constrained by power and processing limitations. Once the best joint antenna grouping is determined, the gNB can further optimize the performance by selecting the best phase and amplitude combinations for the selected antenna elements. This is achieved through analog beamforming, where the gNB may be configured to the phase and amplitude of the signals at each antenna element to form a focused beam in the desired direction (or with different beam characteristics).

In a further implementation, the gNB may communicate antenna indices of elements to be combined in each group and associated analog beamforming weights. Alternately, the gNB may indicate antenna elements in each group and UE can determine analog beamforming weights.

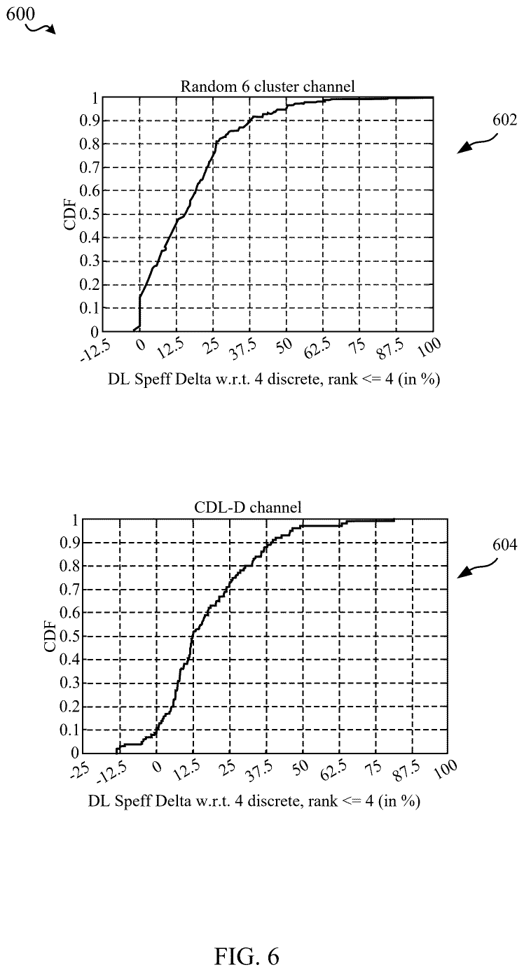

FIG. 6 are chart diagrams of communicate rates for a Random 6 cluster channel and a Cluster Delay Line-D (CDL-D) channel from 3GPP TR 38.901. A first chart diagram 602 demonstrates the performance improvement using network assisted virtual module formation based on a random 6 cluster channel, which refers to a channel model used to simulate the radio propagation environment in wireless communications. Likewise, a second chart diagram 604 demonstrates the performance improvement using network assisted virtual module formation based on a Cluster Delay Line-D (CDL-D) model, which represents Line-of-Sight (LOS) conditions, where there is a direct path between the transmitter and receiver.

For both the random 6 cluster channel and the CDL-D model, the implementation involves the use of N=8 discrete antennas, where K=2 antennas are combined to form a virtual antenna module for each layer, with a rank constraint of ≤4. This implementation may optimize the DL spectral efficiency by leveraging the benefits of antenna combination. The baseline scheme for comparison involves selecting the four best antennas without any combining, distributed over four layers, maintaining a rank of ≤4. This implementation may serve as a reference point to evaluate the effectiveness of the virtual module strategy.

To assess the performance improvements offered by virtual module combinations, a CDF of the percentage improvement in DL spectral efficiency is plotted relative to the baseline scheme. The first chart diagram 602 corresponding to the random 6 cluster channel model may further represent a typical, less structured environment where signal paths are randomly distributed across six clusters, reflecting real-world conditions where signal propagation can be unpredictable. The first chart diagram 604 corresponding to the CDL-D/LOS channel may represent a more controlled environment where there is a direct path between the transmitter and receiver.

The performance plots in the first chart diagram 602 and second chart diagram 604 demonstrate significant rate improvements with the implementation of virtual module generation across both channel structures. At the median level, there is an approximate 15% improvement in data rates, while at the 90th percentile, the improvement exceeds 35%. These results highlight the substantial benefits of using virtual antenna modules in enhancing the efficiency and capacity of wireless communication systems.

The concept of virtual antenna modules in antenna beamforming allows for more flexible and adaptive configurations, enabling better utilization of available antennas and improving overall network performance. By combining antennas into virtual modules, wireless communication systems can achieve higher data rates and more reliable connections, particularly in challenging environments where traditional methods may fall short.

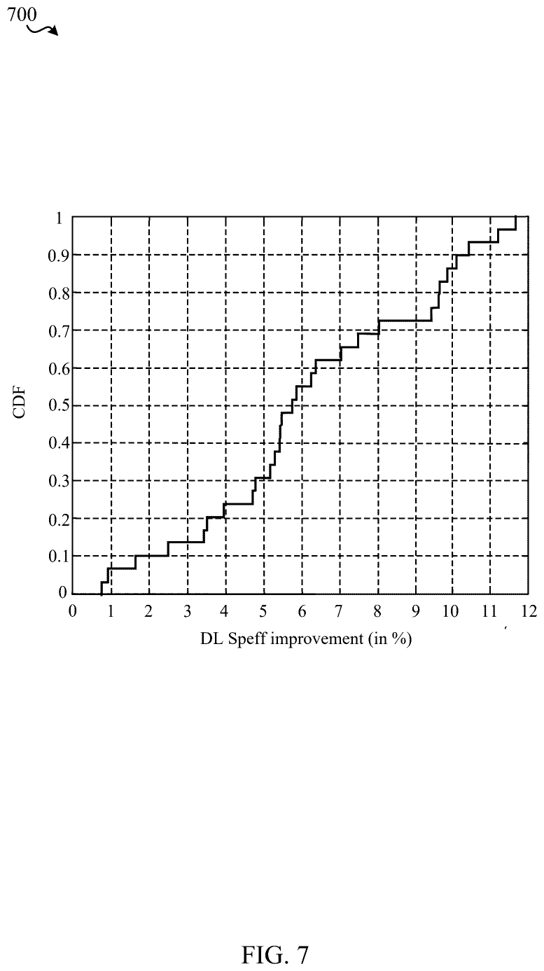

FIG. 7 is a chart diagram 700 of downlink spectral efficiency (DL Speff) improvement using antenna group combination assistance. The chart diagram demonstrates the DL Speff improvement as a percentage relative to a cumulative distribution function (CDF).

In some wireless communication systems, performance improvement through antenna group combination assistance may enhance downlink spectral efficiency (DL SPEFF). Alternately, UL spectral efficiency can also be optimized. The dynamic selection of antenna groups to form virtual antenna modules to optimize signal transmission and reception may not only improve coverage at the UE, but also overall network performance.

The chart diagram 700 represents an example implementation of a downlink spectral efficiency improvement, expressed as a percentage, for a random six-cluster channel. In this implementation, the gNB suggests the optimal joint antenna group selection. This approach is contrasted with a scenario where the UE independently selects a random or suboptimal antenna group using less compute resources, which may result in poorer performance.

Performance comparisons reveal that when the gNB assists in selecting the best antenna groupings to form the virtual antenna modules, there may be approximately a 5% improvement in data rate at the median level. Furthermore, at the 90th percentile, where the most significant gains may be observed, the improvement can reach up to 10%. These enhancements underscore the importance of intelligent antenna group selection in maximizing the efficiency and capacity of wireless communication networks.

The extent of performance improvement can vary based on the specific antenna design used in FR1 and FR3. Different designs may offer varying levels of gain and directivity, influencing how effectively the antenna groups can be combined and utilized. As such, the design and configuration of antennas may be factors in realizing the full potential of beamforming technologies, enabling more robust and efficient communication systems.

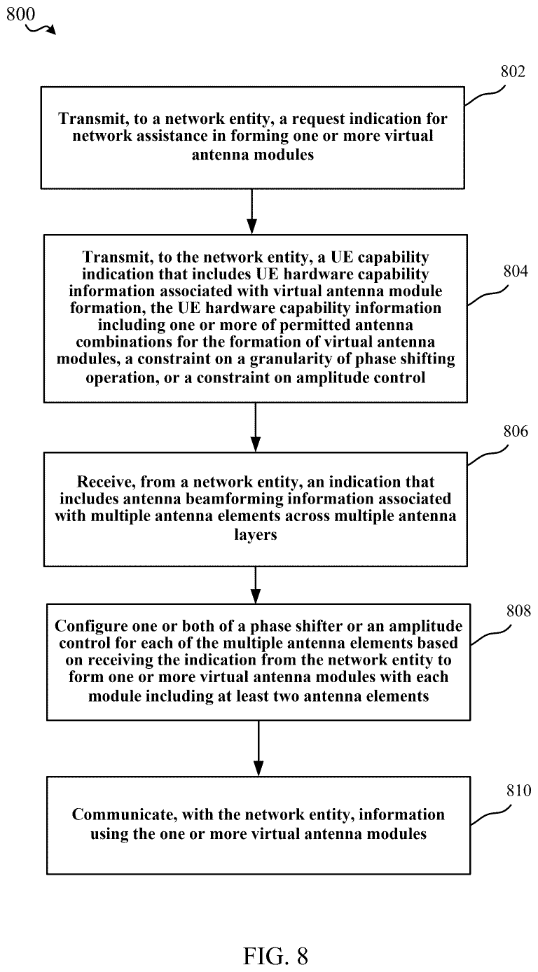

FIG. 8 illustrates a flow chart of an example of a method 800 for wireless communication at a UE, such as the UE 104. In an example, a UE 104 can perform the functions described in method 800 using one or more of the components and techniques described in FIGS. 1, 3, 5, and 10, such as via execution of one or more processors, individually or in combination.

At block 802, the method 800 may transmit, to a network entity, a request indication for network assistance in forming one or more virtual antenna modules. In an aspect, the communicating component 342, e.g., in conjunction with processor(s) 312, memory 316, and/or transceiver 302, may be configured to transmit, to a network entity, a request indication for network assistance in forming one or more virtual antenna modules. Thus, the UE 104, the processor(s) 312, the communicating component 342, or one of its subcomponents may define the means for transmitting, to a network entity, a request indication for network assistance in forming one or more virtual antenna modules.

At block 804, the method 800 may transmit, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control. In an aspect, the communicating component 342, e.g., in conjunction with processor(s) 312, memory 316, and/or transceiver 302, may be configured to transmit, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control. Thus, the UE 104, the processor(s) 312, the communicating component 342, or one of its subcomponents may define the means for transmitting, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control.

In some implementations, the UE hardware capability information may further include at least one of a total number of antenna elements, a total number of available antenna layers, or a number of antenna elements that can be mapped per antenna layer.

In some implementations, the UE hardware capability information may further include an identification of at least one antenna element from the multiple antenna elements that can be mapped to at least one antenna layer from the multiple antenna layers.

In some implementations, the UE hardware capability information may further include an identification of at least one antenna element that is restricted from at least one antenna layer.

At block 806, the method 800 may receive, from a network entity, an indication that includes antenna beamforming information associated with multiple antenna elements across multiple antenna layers. In an aspect, the communicating component 342, e.g., in conjunction with processor(s) 312, memory 316, and/or transceiver 302, may be configured to receive, from a network entity, an indication that includes antenna beamforming information associated with multiple antenna elements across multiple antenna layers. Thus, the UE 104, the processor(s) 312, the communicating component 342, or one of its subcomponents may define the means for receiving, from a network entity, an indication that includes antenna beamforming information associated with multiple antenna elements across multiple antenna layers.

At block 808, the method 800 may configure one or both of a phase shifter or an amplitude control for each of the multiple antenna elements based on receiving the indication from the network entity to form one or more virtual antenna modules with each module including at least two antenna elements. In an aspect, the communicating component 342, e.g., in conjunction with processor(s) 312, memory 316, and/or transceiver 302, may be configured to configure one or both of a phase shifter or an amplitude control for each of the multiple antenna elements based on receiving the indication from the network entity to form one or more virtual antenna modules with each module including at least two antenna elements. Thus, the UE 104, the processor(s) 312, the communicating component 342, or one of its subcomponents may define the means for configuring one or both of a phase shifter or an amplitude control for each of the multiple antenna elements based on receiving the indication from the network entity to form one or more virtual antenna modules with each module including at least two antenna elements.

At block 806, the method 800 may communicate, with the network entity, information using the one or more virtual antenna modules. In an aspect, the communicating component 342, e.g., in conjunction with processor(s) 312, memory 316, and/or transceiver 302, may be configured to communicate, with the network entity, information using the one or more virtual antenna modules. Thus, the UE 104, the processor(s) 312, the communicating component 342, or one of its subcomponents may define the means for communicating, with the network entity, information using the one or more virtual antenna modules.

In some implementations, the method 800 may optionally include transmitting, to the network entity, a set of SRSs for each of the multiple antennas.

In some implementations, the antenna beamforming information may include antenna indices of the multiple antenna elements to be combined in each of the one or more virtual antenna modules and associated sets of analog beamforming weights used with the virtual antenna modules.

In some implementations, the antenna beamforming information may include antenna indices of the multiple antenna elements to be combined in each of the one or more virtual antenna modules. In such implementation, the method 800 may optionally include identifying a set of analog beamforming weights for each of the multiple antenna elements in each of the virtual antenna module.

FIG. 9 illustrates a flow chart of an example of a method 900 for wireless communication at a network entity, such as the base station 102, which may be a gNB. In an example, a base station 102 can perform the functions described in method 900 using one or more of the components and techniques described in FIGS. 1, 2, 5, and 10, such as via execution of one or more processors, individually or in combination.

At block 902, the method 900 may receive, from a network entity, an indication that includes antenna beamforming information associated with multiple antenna elements across multiple antenna layers. In an aspect, the communicating component 342, e.g., in conjunction with processor(s) 312, memory 316, and/or transceiver 302, may be configured to receive, from a network entity, an indication that includes antenna beamforming information associated with multiple antenna elements across multiple antenna layers. Thus, the UE 104, the processor(s) 312, the communicating component 342, or one of its subcomponents may define the means for receiving, from a network entity, an indication that includes antenna beamforming information associated with multiple antenna elements across multiple antenna layers.

In some implementations, the UE hardware capability information may include one or more of permitted antenna combinations, a phase shifter constraint, or an amplitude control constraint associated with the multiple antenna elements of the UE.

In some implementations, the UE hardware capability information may further include at least one of a total number of antenna elements, a total number of available antenna layers, or a number of antenna elements that can be mapped per antenna layer.

In some implementations, the UE hardware capability information may further include an identification of at least one antenna element from the multiple antenna elements that can be mapped to at least one antenna layer from the multiple antenna layers.

In some implementations, the UE hardware capability information may further include an identification of at least one antenna element that is restricted from at least one antenna layer.

In some implementations, the antenna beamforming information may include antenna indices of the multiple antenna elements to be combined in each of the one or more virtual antenna modules and associated sets of analog beamforming weights to be used with the virtual antenna modules.

At block 904, the method 900 may receive, from the UE, a set of SRSs for each of the multiple antenna elements. In an aspect, the communicating component 342, e.g., in conjunction with processor(s) 312, memory 316, and/or transceiver 302, may be configured to receive, from the UE, a set of SRSs for each of the multiple antenna elements. Thus, the UE 104, the processor(s) 312, the communicating component 342, or one of its subcomponents may define the means for receiving, from the UE, a set of SRSs for each of the multiple antenna elements.

At block 906, the method 900 may estimate a channel impulse response for each of the multiple antenna elements based on receiving the set of SRSs. In an aspect, the communicating component 342, e.g., in conjunction with processor(s) 312, memory 316, and/or transceiver 302, may be configured to estimate a channel impulse response for each of the multiple antenna elements based on receiving the set of SRSs. Thus, the UE 104, the processor(s) 312, the communicating component 342, or one of its subcomponents may define the means for estimating a channel impulse response for each of the multiple antenna elements based on receiving the set of SRSs.

At block 908, the method 900 may identify, based on the received indication including the UE hardware capability information, antenna beamforming information including the one or more virtual antenna modules, where each of the one or more virtual antenna modules forming an antenna grouping at the UE from one or both of a phase shifter or an amplitude control for each antenna element from multiple antenna elements associated with multiple antenna layers. In an aspect, the communicating component 342, e.g., in conjunction with processor(s) 312, memory 316, and/or transceiver 302, may be configured to identify, based on the received indication including the UE hardware capability information, antenna beamforming information including the one or more virtual antenna modules, where each of the one or more virtual antenna modules forming an antenna grouping at the UE from one or both of a phase shifter or an amplitude control for each antenna element from multiple antenna elements associated with multiple antenna layers. Thus, the UE 104, the processor(s) 312, the communicating component 342, or one of its subcomponents may define the means for identifying, based on the received indication including the UE hardware capability information, antenna beamforming information including the one or more virtual antenna modules, where each of the one or more virtual antenna modules forming an antenna grouping at the UE from one or both of a phase shifter or an amplitude control for each antenna element from multiple antenna elements associated with multiple antenna layers.

In some implementations, identifying the antenna beamforming information may include the one or more virtual antenna modules is further based on the channel impulse response for each of the multiple antenna elements.

At block 910, the method 900 may transmit, to the UE, an indication that includes the antenna beamforming information associated with multiple antenna elements across multiple antenna layers. In an aspect, the communicating component 342, e.g., in conjunction with processor(s) 312, memory 316, and/or transceiver 302, may be configured to transmit, to the UE, an indication that includes the antenna beamforming information associated with multiple antenna elements across multiple antenna layers. Thus, the UE 104, the processor(s) 312, the communicating component 342, or one of its subcomponents may define the means for transmitting, to the UE, an indication that includes the antenna beamforming information associated with multiple antenna elements across multiple antenna layers.

In some implementations, the method 900 may further include identifying one or both of a phase shifter or an amplitude control for each of the multiple antenna elements.

FIG. 10 is a block diagram of a MIMO communication system 1000 including a base station 102, which may be acting as a network entity, and a UE 104. The MIMO communication system 1000 may illustrate aspects of the wireless communication access network 100 described with reference to FIG. 1. The base station 102 may be an example of aspects of the base station 102 described with reference to FIG. 1. The base station 102 may be equipped with antennas 1034 and 1035, and the UE 104 may be equipped with antennas 1052 and 1053. In the MIMO communication system 1000, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1020 may receive data from a data source. The transmit processor 1020 may process the data. The transmit processor 1020 may also generate control symbols or reference symbols. A transmit MIMO processor 1030 may perform spatial processing (e.g., precoding) on data symbols, control symbols, or reference symbols, if applicable, and may provide output symbol streams to the transmit modulator/demodulators 1032 and 1033. Each modulator/demodulator 1032 through 1033 may process a respective output symbol stream (e.g., for OFDM, etc.) to obtain an output sample stream. Each modulator/demodulator 1032 through 1033 may further process (e.g., convert to analog, amplify, filter, and upconvert) the output sample stream to obtain a DL signal. In one example, DL signals from modulator/demodulators 1032 and 1033 may be transmitted via the antennas 1034 and 1035, respectively.

The UE 104 may be an example of aspects of the UEs 104 described with reference to FIGS. 1 and 2. At the UE 104, the UE antennas 1052 and 1053 may receive the DL signals from the base station 102 and may provide the received signals to the modulator/demodulators 1054 and 1055, respectively. Each modulator/demodulator 1054 through 1055 may condition (e.g., filter, amplify, downconvert, and digitize) a respective received signal to obtain input samples. Each modulator/demodulator 1054 through 1055 may further process the input samples (e.g., for OFDM, etc.) to obtain received symbols. A MIMO detector 1056 may obtain received symbols from the modulator/demodulators 1054 and 1055, perform MIMO detection on the received symbols, if applicable, and provide detected symbols. A receive (Rx) processor 1058 may process (e.g., demodulate, deinterleave, and decode) the detected symbols, providing decoded data for the UE 104 to a data output, and provide decoded control information to a processor 1080, or memory 1082.

The processor 1080 may in some cases execute stored instructions to instantiate the communicating component 242 (see e.g., FIGS. 1 and 2) for virtual module formation in analog beamforming with discrete or uni-polarized antenna elements.

On the uplink (UL), at the UE 104, a transmit processor 1064 may receive and process data from a data source. The transmit processor 1064 may also generate reference symbols for a reference signal. The symbols from the transmit processor 1064 may be precoded by a transmit MIMO processor 1066 if applicable, further processed by the modulator/demodulators 1054 and 1055 (e.g., for SC-FDMA, etc.), and be transmitted to the base station 102 in accordance with the communication parameters received from the base station 102. At the base station 102, the UL signals from the UE 104 may be received by the antennas 1034 and 1035, processed by the modulator/demodulators 1032 and 1033, detected by a MIMO detector 1036 if applicable, and further processed by a receive processor 1038. The receive processor 1038 may provide decoded data to a data output and to the processor 1040 or memory 1042.

The processor 1040 may in some cases execute stored instructions to instantiate the communicating component 342 (see e.g., FIGS. 1 and 3) for virtual module formation in analog beamforming with discrete or uni-polarized antenna elements.

The components of the UE 104 may, individually or collectively, be implemented with one or more ASICs adapted to perform some or all of the applicable functions in hardware. Each of the noted modules may be a means for performing one or more functions related to operation of the MIMO communication system 1000. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 1000.

### Some Additional Examples

The aspects described herein additionally include one or more of the following aspect examples described in the following numbered clauses.

1. An apparatus for wireless communications, comprising:
a transceiver having a plurality of antennas;
one or more memories; and
one or more processors coupled to at least one of the one or more memories and configured to:
   receive, from a network entity, an indication that includes antenna beamforming information associated with multiple antenna elements across multiple antenna layers;
   configure one or both of a phase shifter or an amplitude control for each of the multiple antenna elements based on receiving the indication from the network entity to form one or more virtual antenna modules with each module including at least two antenna elements; and
   communicate, with the network entity, information using the one or more virtual antenna modules

2. The apparatus of clause 1, wherein the one or more processors are further configured to transmit, to the network entity, a request indication for network assistance in forming the one or more virtual antenna modules.

3. The apparatus of clauses 1 and 2, wherein the one or more processors are further configured to transmit, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control.

4. The apparatus of clause 3, wherein the UE hardware capability information further includes at least one of:
a total number of antenna elements,
a total number of available antenna layers, or
a number of antenna elements that can be mapped per antenna layer.

5. The apparatus of clauses 3 and 4, wherein the UE hardware capability information further includes an identification of at least one antenna element from the multiple antenna elements that can be mapped to at least one antenna layer from the multiple antenna layers.

6. The apparatus of clauses 3-5, wherein the UE hardware capability information further includes an identification of at least one antenna element that is restricted from at least one antenna layer.

7. The apparatus of clauses 1-6, wherein the one or more processors are further configured to transmit, to the network entity, a set of sounding reference signals (SRSs) for each of the multiple antennas.

8. The apparatus of clauses 1-7, wherein the antenna beamforming information includes antenna indices of the multiple antenna elements to be combined in each of the one or more virtual antenna modules and associated sets of analog beamforming weights used with the virtual antenna modules.

9. The apparatus of clause 8, wherein the antenna beamforming information includes antenna indices of the multiple antenna elements to be combined in each of the one or more virtual antenna modules, and wherein the one or more processors are further configured to:
identify a set of analog beamforming weights for each of the multiple antenna elements in each of the virtual antenna module.

10. An apparatus for wireless communications, comprising:
a transceiver having a plurality of antennas;
one or more memories; and
one or more processors coupled to at least one of the one or more memories and configured to:
   receive, from a user equipment (UE), an indication for network assistance in forming one or more virtual antenna modules, the indication including UE hardware capability information;
   identify, based on the received indication including the UE hardware capability information, antenna beamforming information including the one or more virtual antenna modules, wherein each of the one or more virtual antenna modules forming an antenna grouping at the UE from one or both of a phase shifter or an amplitude control for each antenna element from multiple antenna elements associated with multiple antenna layers; and
   transmit, to the UE, an indication that includes the antenna beamforming information associated with multiple antenna elements across multiple antenna layers.

11. The apparatus of clause 10, wherein the UE hardware capability information includes one or more of permitted antenna combinations, a phase shifter constraint, or an amplitude control constraint associated with the multiple antenna elements of the UE.

12. The apparatus of clauses 10 and 11, wherein the UE hardware capability information further includes at least one of:
a total number of antenna elements,
a total number of available antenna layers, or
a number of antenna elements that can be mapped per antenna layer.

13. The apparatus of clauses 11 and 12, wherein the UE hardware capability information further includes an identification of at least one antenna element from the multiple antenna elements that can be mapped to at least one antenna layer from the multiple antenna layers.

14. The apparatus of clause 11-13, wherein the UE hardware capability information further includes an identification of at least one antenna element that is restricted from at least one antenna layer.

15. The apparatus of clauses 10-14, wherein the one or more processors are further configured to receive, from the UE, a set of sounding reference signals (SRSs) for each of the multiple antenna elements.

16. The apparatus of clause 15, wherein the one or more processors are further configured to estimate a channel impulse response for each of the multiple antenna elements based on receiving the set of SRSs, and wherein
identifying the antenna beamforming information including the one or more virtual antenna modules is further based on the channel impulse response for each of the multiple antenna elements.

17. The apparatus of clauses 15 and 16, wherein the one or more processors are further configured to identify one or both of a phase shifter or an amplitude control for each of the multiple antenna elements.

18. The apparatus of clauses 10-17, wherein the antenna beamforming information includes antenna indices of the multiple antenna elements to be combined in each of the one or more virtual antenna modules and associated sets of analog beamforming weights to be used with the virtual antenna modules.

19. A method of wireless communications at a user equipment (UE), comprising:
receiving, from a network entity, an indication that includes antenna beamforming information associated with multiple antenna elements across multiple antenna layers;
configuring one or both of a phase shifter or an amplitude control for each of the multiple antenna elements based on receiving the indication from the network entity to form one or more virtual antenna modules with each module including at least two antenna elements; and
communicating, with the network entity, information using the one or more virtual antenna modules.

20. The method of clause 19, further comprising transmitting, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communications, comprising:
a transceiver having a plurality of antennas;
one or more memories; and
one or more processors coupled to at least one of the one or more memories and configured to:
receive, from a network entity, an indication that includes antenna beamforming information associated with multiple antenna elements across multiple antenna layers;
configure one or both of a phase shifter or an amplitude control for each of the multiple antenna elements based on the indication from the network entity to form one or more virtual antenna modules with each module including at least two antenna elements; and
communicate, with the network entity, information using the one or more virtual antenna modules.

2. The apparatus of claim 1, wherein the one or more processors are further configured to transmit, to the network entity, a request indication for network assistance in forming the one or more virtual antenna modules.

3. The apparatus of claim 1, wherein the one or more processors are further configured to transmit, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control.

4. The apparatus of claim 3, wherein the UE hardware capability information further includes at least one of:
a total number of antenna elements,
a total number of available antenna layers, or
a number of antenna elements that can be mapped per antenna layer.

5. The apparatus of claim 3, wherein the UE hardware capability information further includes an identification of at least one antenna element from the multiple antenna elements that can be mapped to at least one antenna layer from the multiple antenna layers.

6. The apparatus of claim 3, wherein the UE hardware capability information further includes an identification of at least one antenna element that is restricted from at least one antenna layer.

7. The apparatus of claim 1, wherein the one or more processors are further configured to transmit, to the network entity, a set of sounding reference signals (SRSs) for each of the multiple antennas.

8. The apparatus of claim 1, wherein the antenna beamforming information includes antenna indices of the multiple antenna elements to be combined in each of the one or more virtual antenna modules and associated sets of analog beamforming weights used with the virtual antenna modules.

9. The apparatus of claim 8, wherein the antenna beamforming information includes antenna indices of the multiple antenna elements to be combined in each of the one or more virtual antenna modules, and wherein the one or more processors are further configured to:
identify a set of analog beamforming weights for each of the multiple antenna elements in each of the virtual antenna module.

10. An apparatus for wireless communications, comprising:
a transceiver having a plurality of antennas;
one or more memories; and
one or more processors coupled to at least one of the one or more memories and configured to:
receive, from a user equipment (UE), an indication for network assistance in forming one or more virtual antenna modules, the indication including UE hardware capability information;
identify, based on the received indication including the UE hardware capability information, antenna beamforming information including the one or more virtual antenna modules, wherein each of the one or more virtual antenna modules forming an antenna grouping at the UE from one or both of a phase shifter or an amplitude control for each antenna element from multiple antenna elements associated with multiple antenna layers; and
transmit, to the UE, an indication that includes the antenna beamforming information associated with multiple antenna elements across multiple antenna layers.

11. The apparatus of claim 10, wherein the UE hardware capability information includes one or more of permitted antenna combinations, a phase shifter constraint, or an amplitude control constraint associated with the multiple antenna elements of the UE.

12. The apparatus of claim 11, wherein the UE hardware capability information further includes at least one of:
a total number of antenna elements,
a total number of available antenna layers, or
a number of antenna elements that can be mapped per antenna layer.

13. The apparatus of claim 11, wherein the UE hardware capability information further includes an identification of at least one antenna element from the multiple antenna elements that can be mapped to at least one antenna layer from the multiple antenna layers.

14. The apparatus of claim 11, wherein the UE hardware capability information further includes an identification of at least one antenna element that is restricted from at least one antenna layer.

15. The apparatus of claim 10, wherein the one or more processors are further configured to receive, from the UE, a set of sounding reference signals (SRSs) for each of the multiple antenna elements.

16. The apparatus of claim 15, wherein the one or more processors are further configured to estimate a channel impulse response for each of the multiple antenna elements based on receipt of the set of SRSs, and wherein the one or more processors are further configured to identify the antenna beamforming information based on the channel impulse response for each of the multiple antenna elements.

17. The apparatus of claim 16, wherein the one or more processors are further configured to identify one or both of a phase shifter or an amplitude control for each of the multiple antenna elements.

18. The apparatus of claim 10, wherein the antenna beamforming information includes antenna indices of the multiple antenna elements to be combined in each of the one or more virtual antenna modules and associated sets of analog beamforming weights to be used with the virtual antenna modules.

19. A method of wireless communications at a user equipment (UE), comprising:
receiving, from a network entity, an indication that includes antenna beamforming information associated with multiple antenna elements across multiple antenna layers;
configuring one or both of a phase shifter or an amplitude control for each of the multiple antenna elements based on receiving the indication from the network entity to form one or more virtual antenna modules with each module including at least two antenna elements; and
communicating, with the network entity, information using the one or more virtual antenna modules.

20. The method of claim 19, further comprising transmitting, to the network entity, a UE capability indication that includes UE hardware capability information associated with virtual antenna module formation, the UE hardware capability information including one or more of permitted antenna combinations for the formation of virtual antenna modules, a constraint on a granularity of phase shifting operation, or a constraint on amplitude control.
